(19) United States
(12) Patent Application Publication
(10) Pub. No.: US 2005/0242532 A1
(43) Pub. Date: Nov. 3, 2005

(54) Suspension system with independent control of ride-height, stiffness and damping

(76) Inventors: Hrishikesh V. Deo, Cambridge, MA (US); Nam Pyo Suh, Sudbury, MA (US)

Correspondence Address: James W. Wiegand, Suite 700, 60 State Street, Boston, MA, 02109, US

(21) Appl. No.: 11/030,343

(22) Filed: Jan. 6, 2005

Related U.S. Application Data
(60) Provisional application No. 60/534,549, filed on Jan. 6, 2004.

(51) Int. Cl. B60G 17/01

(52) U.S. Cl. 280/5.5

(57) ABSTRACT

A vibration isolation system in accordance with the principles of the present invention isolates vibrations between two (or more) objects in a way that may be characterized by the degree of damping, the stiffness of the isolation and isolation system travel. Each of the characteristics; damping, stiffness, and travel, may be adjusted independently of the other characteristics.

### RELATED APPLICATIONS

This application claims benefit of provisional application 60/534,549 entitled, Mathematical Transforms in Design Case Study on Feedback Control of Customizable Automotive Suspension, having the same inventors as the present application and which is hereby incorporated by reference in its entirety.

### FIELD OF THE INVENTION

The invention relates to vibration isolation in mechanical systems and more particularly to vehicle suspension systems.

### BACKGROUND OF THE INVENTION

The design of conventional automotive (or vehicular) suspension systems typically involves a compromise solution for the conflicting requirements of comfort and handling. Suspension systems are typically characterized by the stiffness, damping and ride-height. The trade-off between comfort and handling is easily seen in the design of stiffness, damping and ride-height. For instance, cars need a soft suspension for better comfort (high frequency road-noise isolation), whereas a stiff suspension leads to better handling (low frequency wheel and vehicle attitude control). Cars need high ground clearance on rough terrain, whereas a low center of gravity (CG) height is desired for swift cornering and dynamic stability at high speeds. It is advantageous to have low damping for low force transmission to vehicle frame, whereas high damping is desired for fast decay of oscillations. A suspension system that provides for greater flexibility in the selection of damping, stiffness, and ride-height would therefore be highly desirable.

### SUMMARY

A vibration isolation system in accordance with the principles of the present invention isolates vibrations between two (or more) objects in a way that may be characterized by the degree of damping, the stiffness of the isolation and isolation system neutral position. In accordance with the principles of the present invention, each of the characteristics; damping, stiffness, and neutral position, may be adjusted independently of the other characteristics. The control component may be of a wide range of complexities and may include mechanical, electronic, hydraulic, pneumatic or other types of components. The controller adjusts the isolations system's neutral position and stiffness characteristics, as well as its damping characteristics, independently of one another to respond to user or vibration environment input and to thereby enhance the vibration isolation properties of the system.

A vibration isolation system in accordance with the principles of the present invention is particularly well-suited to application in vehicle suspension systems. A vehicle suspension system in accordance with the principles of the present invention allows for independent control of ride-height (neutral position), stiffness, and damping. In an illustrative short long arm (SLA) suspension embodiment, one spring pivot is configured for controlled movement in a substantially vertical direction and the other is configured for controlled movement in a substantially lateral direction along the lower control arm. In the illustrative embodiment, the top spring pivot controllably moved in the substantially vertical direction and the bottom spring pivot is controllably moved in a lateral direction, but other configurations are contemplated within the scope of this invention. Another embodiment uses a hydropneumatic suspension, in which, the amount of pneumatic fluid is changed to vary the stiffness and the amount of hydraulic fluid is changed to vary the ride-height. A controller is configured to effect changes in stiffness, ride-height and damping. The controller may be configured to vary these parameters in response to user input, to vary the parameters as a function of vehicle speed, or to vary the parameters in response to maneuvering inputs. The aforementioned system may be used to effect real-time alteration (that is, alteration during vehicle operation) of pitch motion centers, of bounce motion centers, of anti-pitch characteristics, anti-dive characteristics, and understeer oversteer (UO) characteristics.

### BRIEF DESCRIPTION OF THE DRAWINGS

The above and further features, aspects, and advantages of the invention will be apparent to those skilled in the art from the following detailed description, taken together with the accompanying drawings in which:

FIG. 1 is a conceptual block diagram of a vibration isolation system in accordance with the principles of the present invention;

FIG. 2 is a schematic diagram of a vehicle suspension system in accordance with the principles of the present invention;

FIG. 3 is a schematic diagram of a quarter-car single degree of freedom model;

FIG. 4 is a block diagram of the system relating road disturbance, actuator input and force to chassis displacement;

FIG. 5 is a block diagram of a control system such as may be employed by a suspension system in accordance with the principles of the present invention;

FIG. 6 is a graphical representation of an optimization of suspension parameters as a function of vehicle speed by minimization of a cost function;

FIG. 7 is a block diagram of a control system such as may be employed by a suspension system in accordance with the principles of the present invention;

FIG. 8 is a schematic diagram of a two degree of freedom half-car pitch plane model for the analysis of the bounce and pitch frequencies of a vehicle;

FIG. 9 is a graphical representation that illustrates the locus of a vehicles motion centers as a function of the ratio of the front and rear natural frequencies; and

FIG. 10 is a schematic diagram of an illustrative hydropneumatic suspension in accordance with the principles of the present invention, in which, the amount of pneumatic fluid is changed to vary the stiffness and the amount of hydraulic fluid is changed to vary the ride-height.

### DETAILED DESCRIPTION

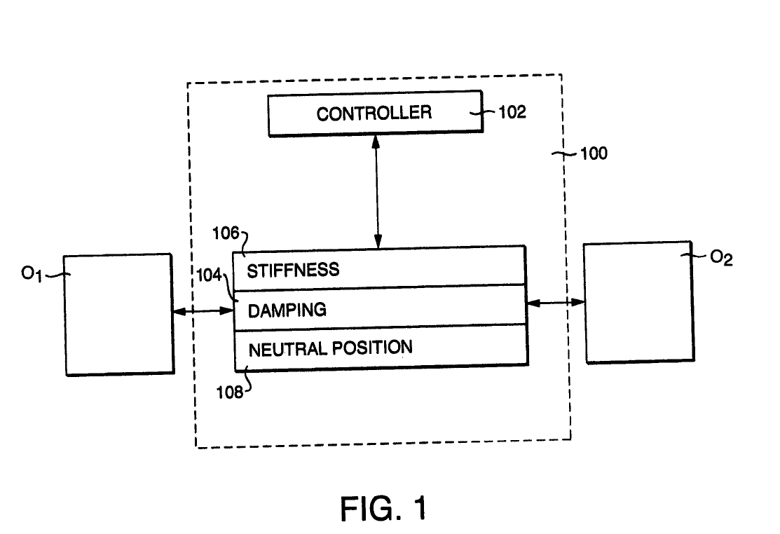

The conceptual block diagram of FIG. 1 provides an overview of a vibration isolation system 100 in accordance with the principles of the present invention. Object O1, subject to vibration, is mechanically linked to object O2 through the vibration isolation system 100, which limits the vibrational energy transferred from object O1 to object O2. The vibration isolation system includes a control mechanism 102 which operates on the physical link between the objects O1 and O2, to adjust damping 104, stiffness 106, and neutral position 108 characteristics of the physical link between the objects. In accordance with the principles of the present invention, each of the components, stiffness, damping, and neutral position, can be adjusted independently of the other components. As will be described in greater detail in the discussion related to a vehicular suspension system embodiment of a vibration isolation system in accordance with the principles of the present invention, the ability to independently adjust stiffness and neutral position provides significant benefits.

Although a vibration isolation system in accordance with the principles of the present invention may be employed to isolate vibrations in all manner of mechanical systems, for clarity and brevity of description, we will discuss, for illustrative purposes, the system's application to vehicular suspensions; application to other mechanical systems will be understood by those of skill in the art.

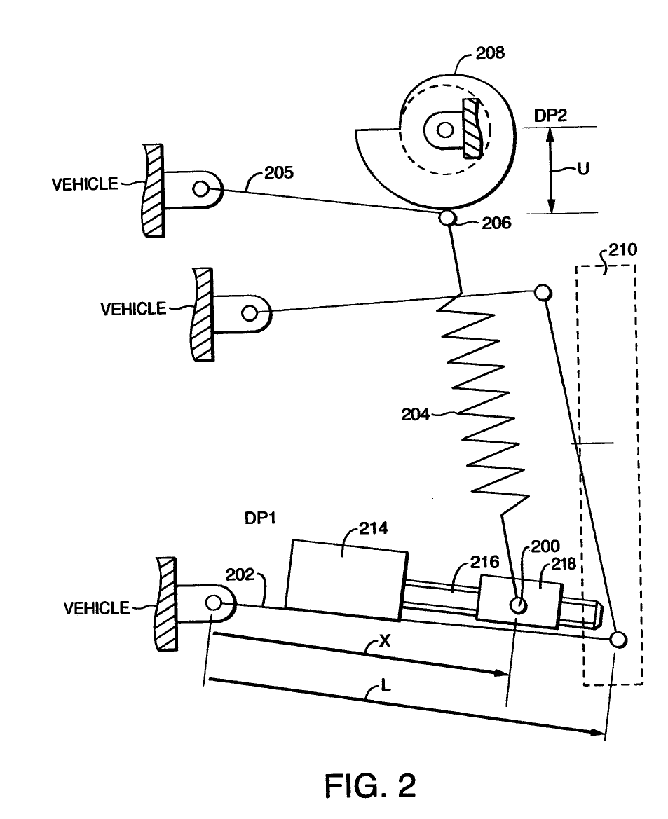

The schematic diagram of FIG. 2 is of an illustrative suspension system embodiment of a vibration isolation system in accordance with the principles of the present invention. This illustrative example depicts a short log arm (SLA) suspension architecture. Those skilled in the art will understand that modifications to other suspension architectures, and vibration isolation systems in general, may be executed to provide independent control of stiffness and neutral position (ride height in a vehicle suspension application) in accordance with the principles of the present invention. In this illustrative embodiment, a lower spring pivot 200 is configured to move along the lower arm 202 of the suspension. Movement of the lower spring pivot 200 alters the effective stiffness seen at the wheel. The upper spring pivot 206 is configured to move in the substantially vertical direction and to thereby alter the associated vehicle's ride height. In this illustrative embodiment, a motor-driven cam 208 operates on the upper spring pivot 206 to effect movement of the pivot 206 substantially in a vertical direction. The resulting displacement is indicated by “U” in the figure. The upper spring pivot 206 may be moved in the substantially vertical direction using a variety of mechanisms and actuators, such as a hydraulic actuator or servo-motor, for example. Changes in the lower spring pivot 200 position x, changes the relation between the wheel travel and spring deflection and thereby alters the effective stiffness K_{w} at the wheel 210, as given by equation 1. In this illustrative embodiment, the lower spring pivot is driven by a linear stage 212, that includes a stepper motor 214, a lead screw 216, carriage 218 supported on a linear bearing. Other mechanisms and actuators for moving the pivot can be easily conceptualized by those skilled in the art. In this illustrative embodiment, the system provides control of damping via orifice control, magneto-rheological means or electro-rheological means. The damper (not shown in the figure for clarity) is connected between the vehicle frame and LCA, in parallel with the spring 204.

$${K}_{w} = {{K}_{s} ( \frac{x}{L} )}^{2} \qquad ( 1 )$$

In existing conventional short long arm (SLA) suspension systems, the upper and the lower spring pivots are fixed to the chassis and the lower control arm (LCA), respectively. In this illustrative embodiment, the upper and lower spring seats are pivoted to the top-arm 205 and the carriage 218 on the LCA respectively. The spring seats for the illustrative suspension are provided this additional degree of freedom to allow for the substantially lateral motion of the lower spring pivot along the LCA. The lower spring seat is pivoted to the carriage 218 on the linear drive, and the upper spring seat is pivoted to the top arm 205. The upper spring pivot is constrained by the top-arm to follow an arc with the length of the top-arm as the radius. Since the length of the top-arm is significantly greater than the length of travel of the upper pivot, the motion of the upper pivot is substantially vertical. Those skilled in the art could conceptualize a variety of mechanisms and actuators to achieve this motion. Rather than the stepper motor, a servo motor or hydraulic actuator may be used for the ride height change. Additionally, in this illustrative embodiment, a roller cam-follower is used to reduce friction and thereby reduce the required torque. The application of axiomatic design theory to suspension systems, to achieve independent control of stiffness and ride-height, and to design and build a prototype suspension system is discussed in, “Mathematical Transforms in Design: Case Study on Feed Back Control of a Customizable Automotive Suspension”, “Variable Stiffness and Variable Ride Height Suspension System and Application to Improved Vehicle Dynamics,” and “Axiomatic Design of Customizable Automotive Suspension”, all by Hrishikesh V. Deo and Nam P. Suh, all of which are hereby incorporated by reference in their entirety. The above description is for the short long arm architecture, but it can be easily incorporated by those skilled in the art in other suspension architectures.

The controller 102 may be employed to control the stiffness, ride height and damping for the illustrative suspension system. A simple illustrative control strategy is mentioned here for the sake of completeness; other controllers can be designed by those skilled in the art. Because stiffness is not affected by any noise factor, stiffness is controlled by open loop control in the illustrative embodiment. Equation (1) is used to calculate the required position, x, of the lower pivot from the desired value of stiffness K_{w} and the controller directs the stepper motor 214 to position the lower spring pivot 200 as required. The desired value of stiffness could reflect a user's preference, or, for example, it may be set to an optimum value according to design and operating considerations such as road conditions, vehicle speed and maneuvering inputs. Ride-height depends not only on the cam position, U, but also on stiffness, and load on the vehicle (that is, noise factor). As a result, any change in stiffness setting or load necessitates a change in cam position, U, by the user to maintain ride-height at the desired value. To achieve insensitivity to stiffness change and load change, a feedback control system for ride-height was designed. That is, the illustrative controller 102 employs a feedback control system to enable the independent adjustment of stiffness and ride height.

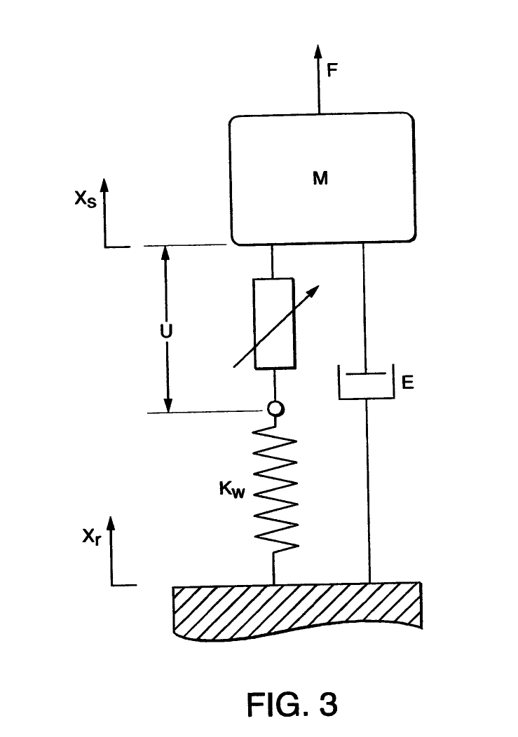

The schematic diagram of FIG. 3 depicts a model used to implement the feedback control system employed by the controller 102 in this illustrative embodiment. For feedback control, the system is modeled as a quarter-car single degree of freedom model as shown in FIG. 3. Cam position, U, (or actuator input in the more general case) is treated as an input to the plant and K_{w} and F (the force acting on the sprung mass) are treated as noise factors. The actuator (motor driven cam in this illustrative embodiment) is modeled as a low bandwidth displacement provider. The actuator provides displacement, U, in series with the spring 204. The response of the sprung mass xₛ to the road disturbance xᵣ, the actuator input U, and the force F acting on the sprung mass is given by the equation 2.
M\dot{x}ₛ+B\dot{x}ₛ+Kxₛ=B\dot{x}ᵣ+Kxᵣ+K(U)+F (2)

Laplace transform of this equation gives the three transfer functions, shown in equation 3, relating road disturbance xᵣ, actuator input U and force F to the chassis displacement xₛ.

$${X}_{s} = ( \frac{Bs + K}{{Ms}^{2} + Bs + K} ) \cdot {X}_{r} + ( \frac{K}{{Ms}^{2} + Bs + K} ) \cdot U + ( \frac{1}{{Ms}^{2} + Bs + K} ) \cdot F \qquad ( 3 )$$

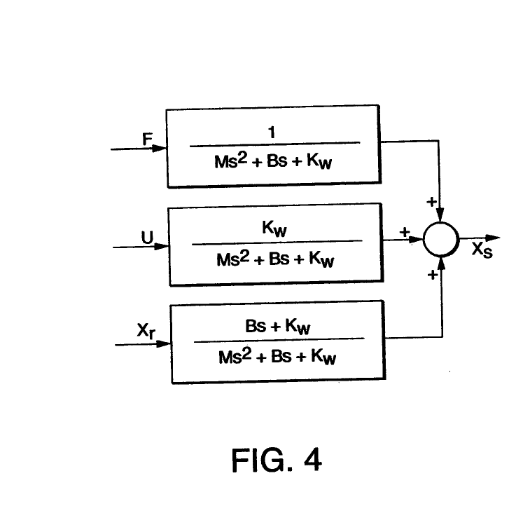

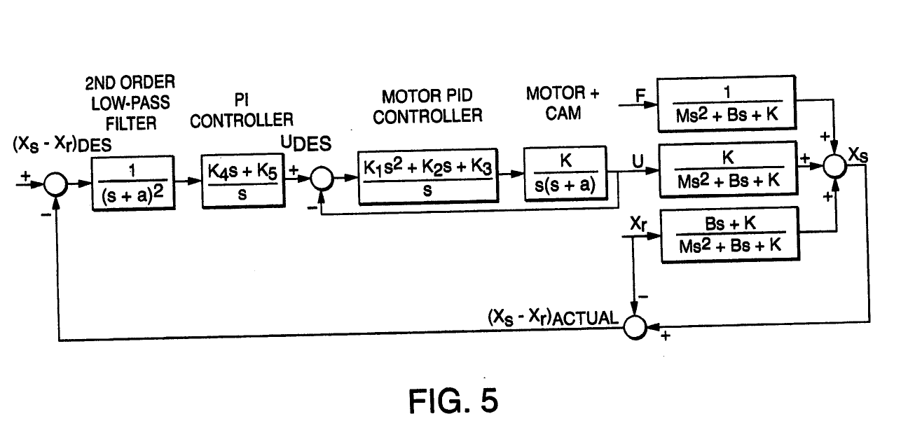

The block diagram of FIG. 4, which reflects equation 3, is used as part of the plant to be controlled. FIG. 5 is a block diagram of the illustrative feedback control system. The system consists of a minor loop and a major loop. The minor loop is a motor position control loop, which includes the actuator dynamics (modeled as a servo-motor and cam in this case) and the PID controller of the motor, with unity feedback. The minor loop (actuator) accepts the desired value for, U, (that is, ride height) as input and provides a displacement U in series with the spring.

The major loop is the ride-height control loop, which comprises of the plant, the minor loop (actuator) and the controller block. In the major loop, the actual ride-height (Xₛ-Xᵣ)_{actual} is measured and compared with the desired ride-height (Xₛ-Xᵣ)_{desired}. In the illustrative embodiment, an off-the shelf rotary encoder connected to the suspension UCA (upper control arm) was used to give a measurement for (Xₛ-Xᵣ)_{actual}. The controller determines the desired value for U, U_{des}, according to a control law based on the difference between the actual and desired ride-height values. The controller architecture of the illustrative customizable suspension is a proportional integral (PI) controller in series with a low pass filter. The plant and actuator are type-0 systems, and hence a PI controller is used to make it a type-1 system and ensure zero steady state error for a step input.

Suspension motion has two components; the first component is a low frequency component caused by the static load or other low frequency inertial forces on the vehicle, and the second component is a high frequency component caused by high frequency road noise. According to the control strategy of the illustrative suspension system, the system isolates the high frequency road noise passively and uses the actuator and control loop to counter the suspension deflection due to low frequency load changes and inertial forces. The 2^{nd} order low-pass filter filters out the high frequency component of the actual ride-height change, (Xₛ-Xᵣ)_{actual}, which is due to road-noise. Introduction of the feedback control system achieves insensitivity to stiffness change and load changes. The resultant system accepts ride-height command (Xₛ-Xᵣ)_{desired} as an input from the user and sets the ride-height to that value.

A prototype described in greater detail in the above-referenced documents is capable of ride-height changes up to 5 in. The range of stiffness change can be quantified by the range of natural frequencies attainable by the stiffness change, The prototype demonstrated a change in natural frequencies in the range 1-1.5 Hz which is significantly greater than the range of natural frequencies encountered in passenger cars (Natural frequencies for Luxury cars are around 1.1 Hz and sports/performance cars are around 1.3-1.4 Hz).

Given a suspension system with independent control of stiffness and ride-height, a suspension system in accordance with the principles of the present invention may find application in many aspects of a vehicle' ride and handling. For example, by independently varying the illustrative adaptive suspension parameter values (stiffness, ride height and damping) over a vehicle's speed range, the suspension system may provide optimum ride and handling performance. The adaptive suspension system may also improve a vehicle's handling characteristics by adapting to maneuvering inputs such as hard acceleration, hard braking or cornering. The system may also apply variable stiffness to achieve real-time alteration of pitch and bounce motion centers and real-time alteration of anti-pitch and anti-dive characteristics. Additionally, by altering the suspension parameters independently, the illustrative suspension system may greatly enhance vehicle stability by adjusting the vehicle's understeer and oversteer (UO) characteristics.

High frequency road noise isolation may be used as a parametric measure of comfort and low frequency wheel alignment parameter changes may be used as a parametric measure of handling. Stiff suspensions provide better handling because low-frequency wheel alignment parameter changes are less severe with stiff suspensions. Soft suspensions provide a smoother, more comfortable ride due to greater high-frequency road noise isolation. A more detailed analysis of the effects of suspension stiffness on the conflicting requirements of passenger comfort and vehicle handling is described in “Variable Stiffness and Variable Ride Height Suspension System and Application to Improved Vehicle Dynamics,” previously incorporated by reference herein.

By providing a facility for the selection of ride stiffness (natural frequency) an adaptive suspension in accordance with the principles of the present invention allows individuals to customize their rides according to their own taste and in response to road conditions. Consequently, vehicle manufacturers needn't commit their production to one style of suspension or another (for example, sporty or comfortable), since consumers may select the style they prefer, The proposed mechanism is capable of providing a continuous range of stiffness, and the user can choose from a continuous range of stiffness or a set of discrete stiffness selections.

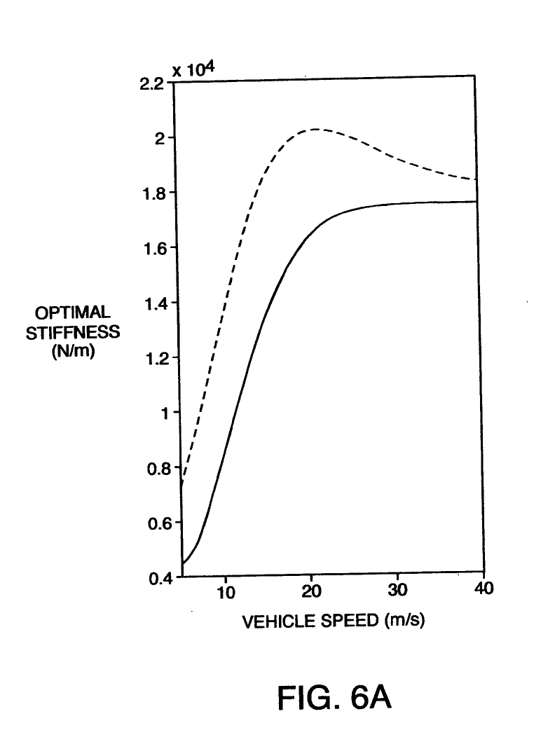

In addition to user selection, the controller of a suspension system in accordance with the principles of the present invention may adjust to inputs, such as road noise, to adapt to changes due, for example to the varying speed of the vehicle. That is, a suspension system in accordance with the principles of the present invention, which provides for the independent adjustment of damping, stiffness, and ride height, may be configured to provide an optimum ride over the vehicle's speed range by adjusting the suspension's parameter values as a function of the vehicle's speed. Road noise may be characterized by a certain power spectral density in terms of spatial frequency υ. If the vehicle is driven at constant speed V, the temporal excitation frequency ω is related to the spatial frequency υ by ω=2πVυ. The power spectral density in terms of temporal frequency keeps changing with the speed of the vehicle and hence the optimum suspension parameters keep changing with speed. In order to optimize suspension parameters in accordance with the principles of the present invention, the requirements of ride comfort, road handling, vehicle attitude and suspension workspace may be included in a cost function. The optimum suspension parameters as a function of vehicle speed are determined to minimize the cost function using various known optimization techniques, The results of one such optimization, described by L. Zuo and S. A. Nayfeh in “Structured H2 Optimization of Vehicle Suspensions,” Vehicle System Dynamics, 2004, which is hereby incorporated by reference are presented in graphical form in FIG. 6. A suspension in accordance with the principles of the present invention, one which permits independent adjustment of stiffness, ride height, and damping, and which provides adaptive suspension parameters (damping and stiffness) may be configured to provide an optimum ride over the entire speed range by changing the suspension parameters as a function of speed, according to a predetermined algorithm or a look-up chart, such as the one depicted in FIG. 6. Optimal stiffness and damping values for the front of the vehicle are represented by the solid lines and optimal stiffness and damping values for the rear of the vehicle are represented by the dashed lines.

In accordance with the principles of the present invention, ride-height change, stiffness change and damping change may be employed in attitude control. Maneuvering inputs, such as hard braking and acceleration, cause dive and squat respectively. In conventional suspensions, an attempt is made to incorporate anti-dive and anti-squat geometries in the suspension kinematics to counter these effects. Lateral forces generated during cornering cause roll, which may be countered using anti-roll bars in conventional suspension systems. Because a suspension system in accordance with the principles of the present invention may manipulate any of the parameters independently of the other parameters, such a suspension provides greater flexibility in choosing control and greater compensation, where needed, in controlling response to inputs such as dive, squat, and lateral forces associated with cornering.

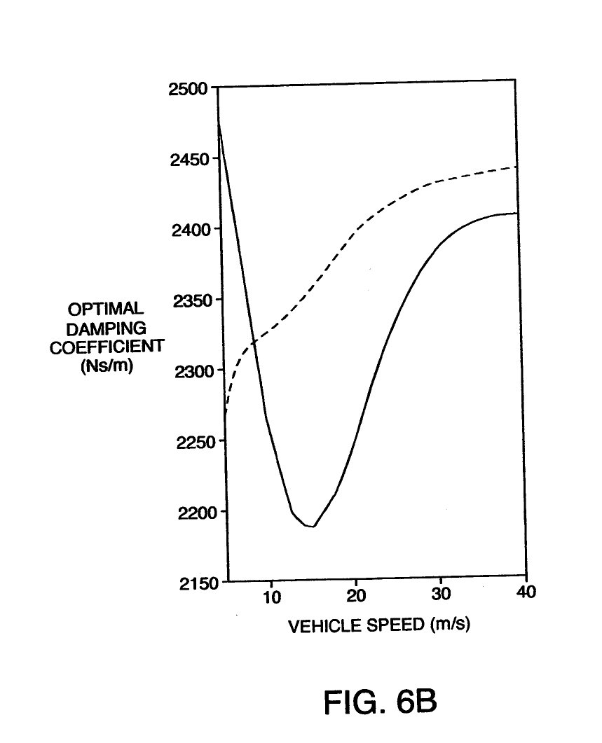

In an illustrative embodiment, the actuators have significant bandwidth and the suspension system can counter roll motion using a feed-forward loop as shown in FIG. 7. The lateral acceleration is measured using an accelerometer (or estimated from the vehicle velocity and the radius of turn). This yields the lateral force from which the load transfer from the inner to the outer set of wheels, can be calculated. This load transfer F is used in the feed-forward control strategy shown in the control loop in FIG. 7. The low pass filter is to filter out high frequency inertial acceleration components, for band-limited actuators. The actuators apply a displacement opposite to that caused by the roll (but reduced by a factor of α, as complete roll-cancellation is undesirable). Similar feed-forward control can be designed for dive-cancellation or squat-cancellation using similar accelerometers to measure the longitudinal acceleration.

Stiffness adjustment may be employed in accordance with the principles of the present invention to alter anti-pitch and anti-dive characteristics. Anti-squat and anti-dive performance may be incorporated in the suspension kinematics and is dependent on the front and rear stiffness. As an example, equation 4 gives the relation for full squat compensation for an independent rear-drive vehicle. In this equation, e and d give the height and longitudinal distance of the equivalent trailing arm pivot from the wheelbase. Radius of the wheel is r, and h and L are the height of the center of gravity and the wheelbase respectively.

$$\frac{e - r}{d} = \frac{h}{L} + \frac{h}{L} \frac{{K}_{r}}{{K}_{f}} \qquad ( 4 )$$

The dependence on front and rear stiffness (Kf and Kr) is manifest in this relation. The illustrative suspension system allows one to independently vary the front and rear stiffness, which, in turn, enables one to alter the anti-squat and anti-dive relations on the fly, without any change in the suspension kinematics. Conflicting requirements may prevent a suspension system from meeting the anti-squat geometry prescribed by equation 5 outright. Such conflicts are described, for example, in “Fundamentals of Vehicle Dynamics,” T. D. Gillespie, Society of Automotive Engineers, Warrendale, Pa. 1992 and “Race Care Vehicle Dynamics,” W. F. and D. L. Miliken, Society of Automotive Engineers, Warrendale, Pa. 1995. However, by changing the front and rear stiffness momentarily during maneuvering inputs such as braking/acceleration a suspension system in accordance with the principles of the present invention may satisfy the anti-dive/anti-squat relations, with the stiffness values set to nominal values dictated by other requirements (such as the desired understeer gradient or the desired location of motion centers) during normal driving conditions.

The illustrative suspension system may be employed to increase damping during cornering, during braking, and during acceleration, to provide improved control of, respectively roll, dive, and squat. The suspension system controller may be configured to sense these events, increase damping and return damping to original settings after the triggering event (e.g., cornering, braking, etc.). The system can thus achieve attitude control and fast decay of oscillations during severe maneuvering inputs by having a stronger damping; but allows better road-noise isolation under normal driving conditions by adopting nominal damping.

In an illustrative embodiment of a vehicular suspension system in accordance with the principles of the present invention, the suspension controller may, in response to user input or to road conditions, adjust ride height independent of other parameters. Front and back (or all wheels) ride height may be adjusted independently of other ride height settings, as well as stiffness and damping. Independent ride-height settings for front and rear permits pitch attitude control of the vehicle, which, in turn can be used to modify aerodynamic forces on the vehicle. The ride height of the illustrative suspension system may be changed on the fly, based on user input, vehicle speed, or maneuvering inputs, for example. Such a system may provide high ground clearance on rough terrain and low center of gravity for swift cornering. Although a soft suspension provides for good high frequency noise isolation (comfort), a soft suspension may contribute to unfavorable suspension travel redistribution between jounce and rebound under overload, excessive wheel attitude changes (leading to directional instability) and excessive vehicle attitude changes (leading to passenger discomfort and excess headlight beam swaying). A system in accordance with the principles of the present invention may employ ride-height control to accommodate handling requirements such as low-frequency body and wheel attitude control, and also address unfavorable suspension travel redistribution. This allows the use of lower stiffness (as compared to a passive suspension) for better comfort without compromising on handling.

In an illustrative embodiment, a suspension system may independently vary the front and rear stiffness of a vehicle to compensate for a vehicle's load distribution and thereby retain a desired front-rear stiffness distribution. Control of the front-rear stiffness distribution provides for control of UO characteristics. By allowing for changes to UO characteristics on the fly, a system such as this illustrative embodiment allows a driver to select a desired handling characteristic for a vehicle, thus providing a degree of customization not previously available. Additionally, the system may be used to gently increase understeer with increasing speed to enhance stability at higher speeds. Additionally, because the system may be employed to tune UO behavior during performance, greater design freedom is afforded to other aspects of a suspension design.

Several factors contribute to the UO behavior of a car and details of the effect of these factors on UO behavior can be found in “Fundamentals of Vehicle Dynamics,” T. D. Gillespie, Society of Automotive Engineers Inc., Warrendale, Pa. 1992 and “Race Care Vehicle Dynamics,” W. F. and D. L. Miliken, Society of Automotive Engineers, Warrendale, Pa. 1995. Contribution to understeer gradient comes from the several factors some of which are mentioned here:
1. Tire cornering stiffness (Weight distribution effect)
2. Camber Thrust
3. Roll steer
4. Lateral Load Transfer
5. Lateral Force Compliance Steer
6. Aligning Torque
7. Steering System
   Some of these factors depend on speed, road conditions (slippery, wet, icy etc.), tire-condition (temperature, life, wear, etc.). A change in these factors could change an understeer car to an oversteer car or vice-versa. The understeer components arising due to camber thrust, roll steer and lateral load transfer depend on stiffness, roll-stiffness and their front-rear distribution. One or a combination of the three understeer components could be used to affect the UO behavior in accordance with the principles of the present invention.

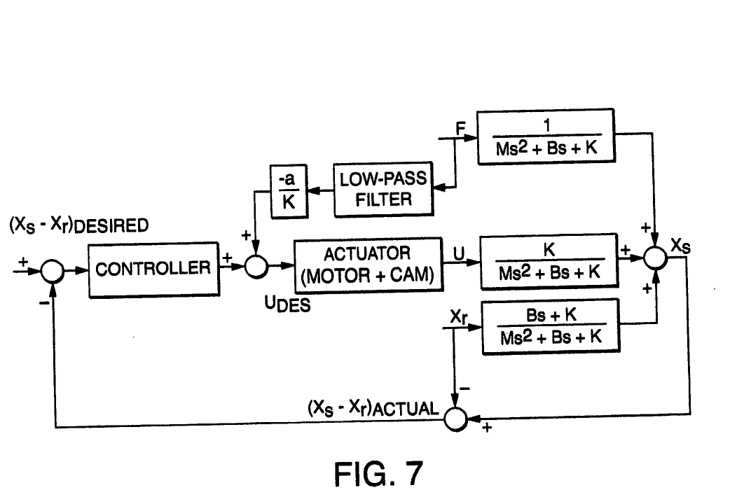

The schematic diagram of FIG. 8 is a two degree of freedom half-car pitch plane model for the analysis of the bounce and pitch frequencies of a vehicle. The differential equations for the bounce and pitch for this simple vehicle model can be given in terms of the mass of the vehicle (M), front and rear ride-rates (Kf and Kr), distance of the front and rear axle to the CG (b and c), pitch moment of inertia (ly) and radius of gyration (k) as follows:

$$[ \begin{matrix}M & 0 \\ 0 & {I}_{y}\end{matrix} ] \{ \begin{matrix}\ddot{x} \\ \ddot{θ}\end{matrix} \} + [ \begin{matrix}( {K}_{f} + {K}_{r} ) & ( {K}_{r} c - {K}_{f} b ) \\ ( {K}_{r} c - {K}_{f} b ) & ( {K}_{f} {b}^{2} + {K}_{r} {c}^{2} )\end{matrix} ] \{ \begin{matrix}x \\ θ\end{matrix} \} = \{ \begin{matrix}0 \\ 0\end{matrix} \} \qquad ( 5 )$$

This is an eigenvalue problem and the two eigenvalues give the pitch and bounce frequencies and the eigenvectors indicate the pitch and bounce modes. The eigenvectors determine the predominant modes of oscillations (or in other words the location of the motion centers—pitch center and bounce center). The ratios of the pitch and bounce frequencies and the location of the motion centers are dependent on the relative values of the natural frequencies of the front and rear suspension, which are given by:

$${ω}_{f} = \sqrt{\frac{{K}_{f} g}{{W}_{f}}} and {ω}_{r} = \sqrt{\frac{{K}_{r} g}{{W}_{r}}} \qquad ( 6 )$$

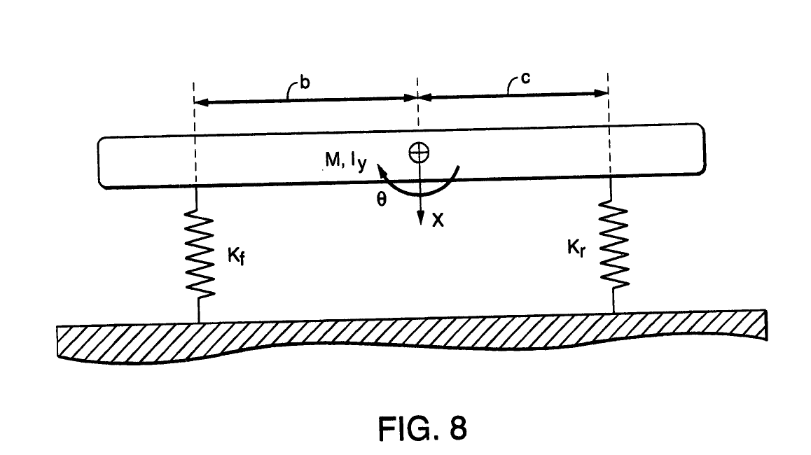

FIG. 9 shows the locus of the motion centers as a function of the ratio of the front and rear natural frequencies. With equal frequencies, one center is at the CG location and the other is at infinity. Equal frequencies result in decoupled or “pure” bounce and pitch motions. With a higher front frequency, the motion is coupled with the bounce center ahead of the front axle and the pitch center towards the rear axle. A lower front frequency puts the bounce center behind the rear axle and the pitch center forward near the front axle. The latter case (front lower frequency)is widely recognized by those skilled in the art as the best for achieving “good ride”, and is typically followed in the passenger cars

As seen from equation 6, the front and rear natural frequencies depend on the front and rear stiffness as well as the loading on the front and rear wheels. Typically loading increases the load on the rear wheels (Wᵣ) greater than the load on the front wheels (W_{f}) and as a result, the rear natural frequency reduces. In extreme cases, the condition of lower front frequency may be violated and could result in deteriorated ride. The proposed suspension system allows us to independently vary the front and rear stiffness to compensate for the load distribution and maintain the desired front-rear stiffness distribution (or the desired location of motion centers).

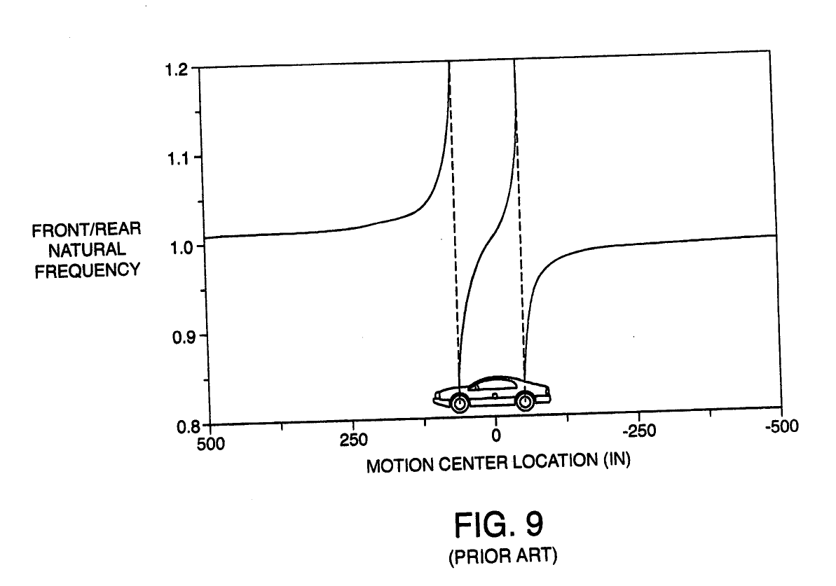

The schematic diagram of FIG. 10 is of an illustrative hydropneumatic suspension in accordance with the principles of the present invention, in which, the amount of pneumatic fluid is changed to vary the stiffness and the amount of hydraulic fluid is changed to vary the ride-height. In this illustrative embodiment a wheel 1000 is coupled to a vehicle chassis (not shown) through a plunger 1002 that engages an incompressible fluid filled chamber 1004 that is, in turn, operatively communicative with a compressible fluid chamber 1006. In operation, the pneumatic fluid (gas) in the chamber 1006 operates as a variable stiffness spring, the stiffness of which may be increased or decreased by, changing the amount of the gas in the chamber. The relation between stiffness and amount of gas in this illustrative embodiment is given by equation 8, where P and V are respectively the pressure and volume of the gas in the chamber, Pₒ and Vₒ are respectively the pressure and volume at neutral position respectively, A is the cross-sectional area of the gas chamber which acts as a spring and γ is the specific heat ratio of the gas. This gas spring modeling in this illustrative embodiment assumes the gas compression and expansion as an adiabatic reversible process as described by equation 7. Changing the amount of gas changes stiffness as well as ride-height, but this change in ride-height is compensated for by changing the amount of incompressible fluid as shown in equation 9. The incompressible fluid (liquid) operates as an actuator in series with the variable spring of the compressible gas. The vehicle's ride-height may be altered by altering the amount of fluid in the chamber 1004. Such adjustments to ride-height will not affect the suspension's stiffness.

$$\begin{matrix}P {V}^{γ} = K = {P}_{0} {V}_{0}^{γ} & ( 7 ) \\ Stiffness = \frac{ⅆ F}{ⅆ x} = - {A}^{2} \frac{ⅆ P}{ⅆ V} = \frac{γ {P}_{0} {V}_{0}^{γ} {A}^{2}}{{V}^{γ + 1}} {( = \frac{γ {P}_{0} {A}^{2}}{{V}_{0}} )}_{for V = {V}_{0}} & ( 8 ) \\ \{ \begin{matrix} FR 1 \text{:} Control Stiffness \\ FR 2 \text{:} Control Ride - height\end{matrix} \} = [ \begin{matrix}X & O \\ X & X\end{matrix} ] \{ \begin{matrix} DP 1 \text{:} Amount of gas \\ DP 2 \text{:} Amount of liquid\end{matrix} \} & ( 9 )\end{matrix}$$

The foregoing description of specific embodiments of the invention has been presented for the purposes of illustration and description. It is not intended to be exhaustive or to limit the invention to the precise forms disclosed, and many modifications and variations are possible in light of the above teachings. The embodiments were chosen and described to best explain the principles of the invention and its practical application, and to thereby enable others skilled in the art to best utilize the invention. It is intended that the scope of the invention be limited only by the claims appended hereto.

1. An apparatus for isolating vibration between two bodies comprising;
a combination of physical elements linking the two bodies, the combination of which is characterized by stiffness, damping, and neutral position characteristics and the combination of elements is configured to allow each of the characteristics to be adjusted independently of the other characteristics.

2. An apparatus for isolating vibration between two bodies couple to one another comprising;
means for providing stiffness in the coupling between the two bodies;
means for providing damping in the coupling between the two bodies; and
means for providing a neutral position in the coupling between the two bodies, said means configured to allow the stiffness, damping and neutral position characteristics to be adjusted independently of each other.

3. The apparatus of claim 2 further comprising a controller configured to adjust the stiffness and neutral position characteristics in response to human intervention.

4. The apparatus of claim 3 wherein the controller is configured to adjust the stiffness and neutral position characteristics in response to feedback from the bodies for which vibration is being isolated.

5. A vehicle suspension system comprising:
a combination of physical elements linking a vehicle wheel and vehicle chassis, the combination of which is characterized by stiffness, damping, and ride-height and the combination of elements is configured to allow ride-height, stiffness and damping to be adjusted independently of each other.

6. A vehicle suspension system coupling a vehicle chassis and wheel comprising;
means for providing stiffness in the coupling between the wheel and chassis;
means for providing damping in the coupling between the wheel and chassis; and
means for providing a neutral position in the coupling between the wheel and chassis, said system configured to be adjusted ride-height, stiffness and damping independently of each other.

7. The suspension system of claim 6 further comprising a controller configured to adjust the ride-height and stiffness independently in response to human intervention.

8. The apparatus of claim 6 wherein the controller is configured to adjust the ride-height, stiffness and damping independently in response to feedback from the vehicle for which suspension is being provided.

9. The suspension system of claim 6 wherein a spring supplies a stiffness component and the spring is attached to the suspension system with controllably adjustable lower and upper spring pivots.

10. A vehicle suspension system comprising:
a combination of physical elements linking a vehicle wheel and vehicle chassis, the combination of which is characterized by stiffness, damping, and ride-height characteristics and the combination of elements is configured to allow each of the characteristics to be adjusted independently of the other characteristics, and a controller, the controller configured to adjust the stiffness, ride-height, and damping characteristics independently of one another.

11. The suspension system of claim 10 wherein the system is a modified short long arm suspension system that includes upper and lower spring pivots and one spring pivot is configured for controlled movement in a substantially vertical direction and the other spring pivot is configured for controlled movement in a substantially lateral direction.

12. The suspension system of claim 10 wherein the controller is configured to make adjustments in response to user input.

13. The suspension system of claim 10 wherein the controller is configured to make adjustments as a function of vehicle speed.

14. The suspension system of claim 10 wherein the controller is configured to make adjustments in response to maneuvering inputs.

15. The suspension system of claim 10 wherein the controller is configured to make adjustments to alter pitch and bounce motion centers.

16. The suspension system of claim 10 wherein the controller is configured to make adjustments to alter anti-pitch characteristics.

17. The suspension system of claim 10 wherein the controller is configured to make adjustments to alter anti-dive characteristics.

18. The suspension system of claim 10 wherein the controller is configured to make adjustments to alter anti-squat characteristics.

19. The suspension system of claim 10 wherein the controller is configured to make adjustments to alter understeer oversteer (UO) characteristics.

20. A suspension system comprising:
upper and lower suspension control arms operably coupled to a vehicle chassis and to a vehicle wheel;
a spring coupled at its upper end to the vehicle chassis through a first actuator that is configured to move the upper end of the spring in a substantially vertical direction, and at its other end to the lower control arm through a second actuator that is configured to move the lower end of the spring in a substantially horizontal direction; and
a damper operably connected between the upper and lower suspension control arms.

21. A suspensions system comprising:
a compressible gas spring, and
an incompressible liquid actuator, the compressible gas spring and incompressible liquid actuator coupled in series between a vehicle chassis and a vehicle wheel.
